(19) United States
(12) Patent Application Publication
(10) Pub. No.: US 2020/0359702 A1
(43) Pub. Date: Nov. 19, 2020

(54) Disposable Electronic Cigarette

(71) Applicant: Shenzhen ACEVAPE Technology Co.Ltd, Shenzhen (CN)

(72) Inventor: Yanni Cheng, Shenzhen (CN)

(73) Assignee: Shenzhen ACEVAPE Technology Co.Ltd

(21) Appl. No.: 16/412,442

(22) Filed: May 15, 2019

(51) Int. Cl. A24F 47/00; H05B 1/02; H05B 3/14

(52) U.S. Cl. CPC A24F 47/008; H05B 3/141; H05B 1/0297

(57) ABSTRACT

The present disclosure relates to a disposable electronic cigarette, including: a casing, a bottom cover is arranged at the bottom of the casing; an atomizer is accommodated in the casing, and the atomizer passes through a sealing ring of fixing member to arrange on the fixing member. The fixing member is further provided with a microphone, and the fixing member divides the electronic cigarette into a top chamber and a bottom chamber. The bottom chamber is provided with a battery, and the top chamber opens an atomizing tube shell and a tobacco tar chamber. The atomizing tube shell is connected to the atomizer and is not in communication with the tobacco tar chamber; the bottom chamber is further provided with a battery switch, the battery switch is connected to the battery to control on and off of the battery.

### TECHNICAL FILED

The present disclosure relates to the field of electronic cigarette technology, in particular to a disposable electronic cigarette which has a good sealing environment and maintains sufficient power from the factory to the consumers.

### BACKGROUND

The electronic cigarette converts electric energy into heat energy by electronic technology, and the solution with tobacco aroma is atomized into smoky by heating for smokers to smoke. The electronic cigarette will not produce open flames when it is used, which can effectively improve the performance of fire prevention. At the same time, because the electronic cigarette does not burn when it is used, so that a mellow smoke odor can be obtained, which meets the requirements of smokers. As an important component of the electronic cigarette, the atomizer of the electronic cigarette controls smoke output and working state through high-tech intelligent chips and pneumatic switches. In the interior of the atomizer of the electronic cigarette, the tobacco tar is transferred to the interior of the atomizer, and the heating wire in the atomizer works to produce high temperature, so that the tobacco tar is atomized into smoke, thereby when people smoke, the effect of “swallowing clouds and blowing fogs” can be achieved.

All of traditional disposable electronic cigarettes with batteries have the phenomenon of self-consumption of batteries and PCB boards. Because disposable electronic cigarettes with batteries can not be recharged again, there are too many links and too long time in the process from the assembly day to customer warehouses domestic and overseas, then transfer to stores, and then sell to consumers. Even some products will be backlogged up in warehouses for half a year to one year, which will lead to the product itself consuming electricity, and then the power of the products is insufficient when the products are sold to consumers, such that the normal performance of the product can not be guaranteed. The generation of self-consuming power causes the battery power insufficient, such that the battery power has been alarmed and stopped working before the oil in the product are atomized completely, which will cause the quality problems of the product, and lead to dissatisfaction and complaints from consumers;

Secondly, the traditional disposable tobacco tar leakage is a problem in the electronic cigarette industry at present, the oil leakage will lead to damage to pneumatic switches, PCB boards and batteries; serious oil leakage reduces oil storage, some even run out of the oil; the above two situations, if serious, will directly lead to the failure use of the product.

Thirdly, the tobacco tar in the traditional structure atomizer is in contact with the external air, when the tobacco tar is exposed in the air too long which will lead to the loss of taste and the change of taste. At the same time, there will be the phenomenon of oil leakage in the atomizer, which will cause the reduction of oil storage, the appearance of oil pollution, and the failure use of the product due to oil leakage.

Therefore, there is an urgent demand to solve the problem that the tobacco tar is easily exposed to the outside air, which causes the tobacco tar to expire and deteriorate; oil leakage damages the internal microphone of the product, the appearance of the product; the power shortage of the disposable tobacco tar.

### SUMMARY OF THE DISCLOSURE

In view of the above shortcomings of the current technology, the present disclosure provides a disposable electronic cigarette, which focuses on setting battery switches, adding sealing plugs, and adopting a new technology of tobacco tar core isolation structure, and can effectively solve the problems in the current technology.

To achieve the above purpose, the present disclosure adopts the following technical solution: a disposable electronic cigarette, including a casing, a bottom cover is arranged at the bottom of the casing. An atomizer is accommodated in the casing. The atomizer passes through a sealing ring of a fixing member to arrange on the fixing member. The fixing member is further provided with a microphone. The fixing member divides the electronic cigarette into a top chamber and a bottom chamber, the bottom chamber is provided with a battery, and the top chamber opens an atomizing tube shell and a tobacco tar chamber. The atomizing tube shell is connected to the atomizer and is not in communication with the tobacco tar chamber. The bottom chamber is further provided with a battery switch, the battery switch is connected to the battery to control on and off of the battery.

As a preferred technical solution of the present disclosure, the atomizer includes an atomizing tube, a heating wire, a silicone pad and a sealing ring. The sealing ring, the heating wire and the silicone pad are arranged in sequence in the atomizing tube, the sealing ring is arranged at one end far from the fixing member, the atomizing tube is provided with an oil inlet hole, and the atomizer is connected with the tobacco tar chamber through the oil inlet hole.

As a preferred technical solution of the present disclosure, an external part of the atomizer is provided with a sealing sleeve, wherein the sealing sleeve is wrapped the atomizer, and the sealing sleeve isolates the connection between the tobacco tar chamber and the atomizer.

As a preferred technical solution of the present disclosure, a pulling valve is provided in the sealing sleeve; pulling out of the pulling valve controls the connection between the oil inlet hole and the tobacco tar chamber.

As a preferred technical solution of the present disclosure, a sealing plug is provided inside the atomizer; the sealing plug is capable of passing through the atomizing tube shell to isolate the atomizer from contacting with tobacco tar and gas.

As a preferred technical solution of the present disclosure, the battery is connected with the microphone and the atomizer through a positive electrode and a negative electrode.

As a preferred technical solution of the present disclosure, the casing is provided with an oil injection hole, and the tobacco tar chamber is sealed by an oil injection plug arranged on the oil injection hole.

As a preferred technical solution of the present disclosure, the sealing sleeve, the, sealing plug, the sealing ring and the sealing ring of fixing member are made of transparent silica gel material.

As a preferred technical solution of the present disclosure, the heating wire is ceramic heating wire.

In combination with the above technical solutions, the disposable electronic cigarette provided by the present disclosure is different from traditional disposable electronic cigarettes. The beneficial effects of the present disclosure are shown as following:

1. It can solve the problems of short-term or long-term transportation and storage of products, battery self-consumption power and PCB board self-consumption power.

It greatly guarantees the performance of the product, enabling consumers to have a better experience of high performance of the product and ensure product quality.

2. It can solve the oil leakage problem of the atomizer, and completely ensures that the oil will not leak, which better protects all the quality of products, so that pneumatic switches and batteries will not be damaged by leakage. At the same time, the oil storage volume will not be reduced.
3. Completely isolating the oil from the external air can solve the oil leakage better and ensure the pure taste of tobacco tar; while maintaining a clean and tidy appearance and the product functionality.

### BRIEF DESCRIPTION OF THE DRAWINGS

In order to illustrate the technical solution in the embodiments of the present disclosure more clearly, the drawings that need to be used in the embodiments will be briefly introduced below. Obviously, the drawings described below are just some embodiments of the present disclosure, and other drawings can be obtained from these drawings for the ordinary person skilled in the art without any creative effort.

FIG. 1 is a structural schematic diagram of the disposable electronic cigarette described in the present disclosure.

FIG. 2 is a schematic perspective view of the disposable electronic cigarette described in the present disclosure.

FIG. 3 is a top view of the disposable electronic cigarette described in the present disclosure.

The reference numerals indicate that:

1. casing; 2. bottom cover; 3. sealing sleeve; 4. pulling valve; 5. sealing plug; 6. sealing ring of fixing member; 7. fixing member; 8. microphone; 9. battery; 10. battery switch; 101. sealing ring; 102. heating wire; 103. silicone pad; 104. atomizing tube; 105. oil inlet hole; 106. atomizing tube shell; 111. oil injection plug; 112. oil injection hole.

### DETAILED DESCRIPTION OF THE EMBODIMENTS

The technical solution of the present disclosure will be described clearly and completely in conjunction with the accompanying drawings. Obviously, the described embodiments are part of the embodiments of the present disclosure, not all of them. Based on the embodiments of the present disclosure, all other embodiments acquired by the ordinary person skilled in the art without creative effort fall within the scope of protection of the present disclosure.

In the description of the present disclosure, it is necessary to note that the directions or positions indicated by the terms “one end”, “inner”, “upper”, “lower” are based on the directions or positions shown in the drawings, only for the convenience of describing the present disclosure and simplifying the description, rather than indicating or implying that the devices or components referred to must have a specific orientation and be constructed and operated in a specific orientation. Therefore, it cannot be understood as a limitation of the present disclosure.

In the description of the present disclosure, it should be noted that unless otherwise specified and defined, the terms “connection” and “setting” should be understood in a broad sense, such as a fixed connection, a detachable connection, or an integrated connection, or a mechanical connection or an electrical connection. When a component is described as “connected” to another component, it can be directly connected to another component, or there may be one or more components between the two components. For those skilled in the art, the specific meaning of the above terms in the present disclosure can be understood in specific circumstances.

In addition, the technical features described in the different embodiments of the present disclosure described below can be combined with each other as long as the combined structures is without conflict between them; moreover, the “and/or” described includes two possible embodiments of “and” and “or”.

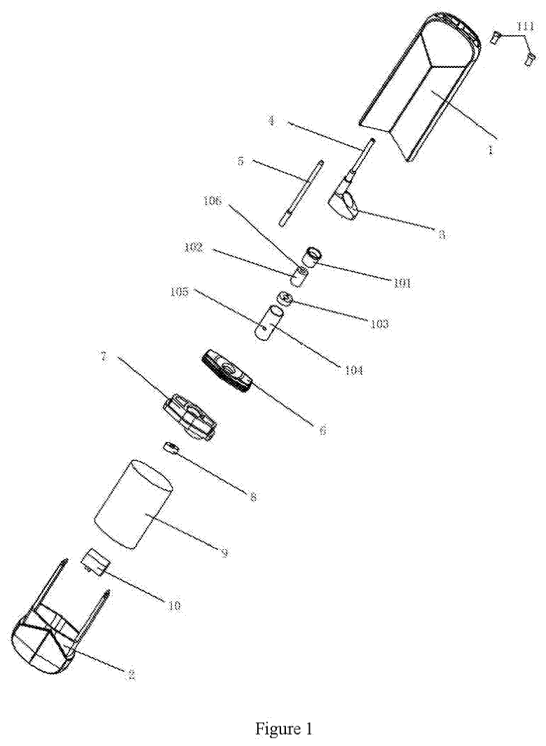

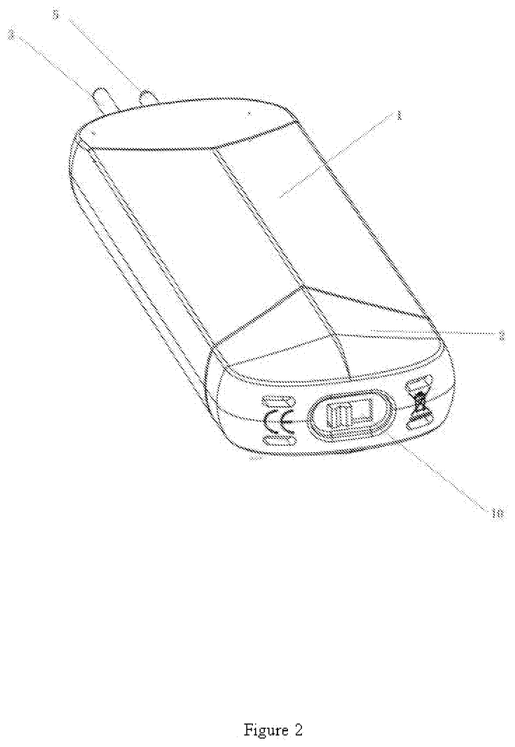

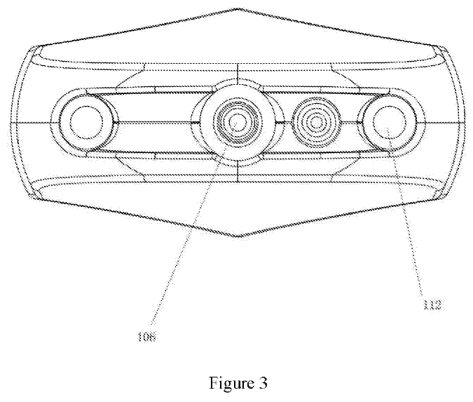

As shown in FIGS. 1 to 3, the present disclosure provides a disposable electronic cigarette, including a casing 1. A bottom cover 2 is arranged at the bottom of the casing 1. An atomizer is accommodated in the casing 1, the atomizer passes through a sealing ring of fixing member 6 to be arranged on a fixing member 7. The fixing member 7 is further provided with a microphone 8. The fixing member 7 divides the electronic cigarette into a top chamber and a bottom chamber, the bottom chamber is provided with a battery 9, and the top chamber is set with an atomizing tube shell 106 and an tobacco tar chamber. The atomizing tube shell 106 is connected to the atomizer and is not in communication with the tobacco tar chamber. The atomizer includes an atomizing tube 104, a heating wire 102, a silicone pad 103 and a sealing ring 101. The sealing ring 101, the heating wire 102 and the silicone pad 103 are arranged in sequence in the atomizing tube 104. The sealing ring 101 is arranged at one end far from the fixing member 7. The atomizing tube 104 is provided with an oil inlet hole 105, and the atomizer is connected with the tobacco tar chamber through the oil inlet hole 105.

As shown in FIGS. 1 to 3, in embodiment one, the present disclosure includes a casing 1. A bottom cover 2 is arranged at the bottom of the casing 1. An atomizer is accommodated in the casing 1, the atomizer passes through a sealing ring of fixing member 6 to arrange on the fixing member 7. The fixing member 7 is further provided with a microphone 8. The fixing member 7 divides the electronic cigarette into a top chamber and a bottom chamber, the bottom chamber is provided with a battery 9, and the top chamber is set with an atomizing tube shell 106 and an tobacco tar chamber; the atomizing tube shell 106 is connected to the atomizer and is not in communication with the tobacco tar chamber. The bottom chamber is further provided with a battery switch 10, the battery switch 10 is connected to the battery 9 to control on and off of the battery 9. As the present disclosure is mainly used on disposable electronic cigarette which can not be charged, adding switch function is capable of preventing battery self-consumption and loss of power, and preventing products from automatically working due to external environment at the same time.

As shown in FIGS. 1 to 3, in embodiment two, a disposable electronic cigarette, includes a casing 1. A bottom cover 2 is arranged at the bottom of the casing 1. An atomizer is accommodated in the casing 1, the atomizer passes through a sealing ring of fixing member 6 to arrange on a fixing member 7. The fixing member 7 is further provided with a microphone 8. The fixing member 7 divides the electronic cigarette into a top chamber and a bottom chamber. The bottom chamber is provided with a battery 9, and the top chamber is set with an atomizing tube shell 106 and a tobacco tar chamber. The atomizing tube shell 106 is connected to the atomizer and is not in communication with the tobacco tar chamber. The atomizer includes an atomizing tube 104, a heating wire 102, a silicone pad 103 and a sealing ring 101. The sealing ring 101, the heating wire 102 and the silicone pad 103 are arranged in sequence in the atomizing tube 104. The sealing ring 101 is arranged at one end far from the fixing member 7. The atomizing tube 104 is provided with an oil inlet hole 105, and the atomizer is connected with the tobacco tar chamber through the oil inlet hole 105. An external part of the atomizer is provided with a sealing sleeve 3, wherein sealing sleeve 3 wraps the atomizer, and the sealing sleeve 3 isolates the connection between the tobacco tar chamber and the atomizer. A pulling valve 4 is provided in the sealing sleeve 3; pulling of the pulling valve 4 controls the connection between the oil inlet hole 105 and the tobacco tar chamber. By adding a sealing sleeve 3, the present disclosure can be used on all electronic cigarette atomizers in which the tobacco tar are stored. Adding a sealing sleeve 3 on the atomizing tube shell can completely isolate the oil from the external air, which can better solve the oil leakage and ensure the pure taste of the tobacco tar, while keeping the appearance clean and tidy. It solves the problem of oil leakage in electronic cigarette industry and the problem that the taste becomes bad after long storage.

As shown in FIGS. 1 to 3, in embodiment two, a disposable electronic cigarette, includes a casing 1. A bottom cover 2 is arranged at the bottom of the casing 1. An atomizer is accommodated in the casing 1, the atomizer passes through a sealing ring of fixing member 6 to be arranged on a fixing member 7. The fixing member 7 is further provided with a microphone 8. The fixing member 7 divides the electronic cigarette into a top chamber and a bottom chamber, the bottom chamber is provided with a battery 9, and the top chamber is set with an atomizing tube shell 106 and a tobacco tar chamber. The atomizing tube shell 106 is connected to the atomizer and is not in communication with the tobacco tar chamber. The atomizer includes an atomizing tube 104, a heating wire 102, a silicone pad 103 and a sealing ring 101. The sealing ring 101, the heating wire 102 and the silicone pad 103 are arranged in sequence in the atomizing tube 104. The sealing ring 101 is arranged at one end far from the fixing member 7, the atomizing tube 104 is provided with an oil inlet hole 105, and the atomizer is connected with the tobacco tar chamber through the oil inlet hole 105. A sealing plug 5 is provided inside the atomizer; the sealing plug 5 is capable of passing through the atomizing tube shell 106 to isolate the atomizer from contacting with tobacco tar and gas. By adding sealing plug 5, the present disclosure is mainly used on the disposable electronic cigarette, which protects the quality of the product and prevents the pneumatic switch and battery from being damaged by leakage. At the same time, it keeps the oil storage capacity not to be reduced; and solves the problem of oil leakage of the disposable electronic cigarette, which reduces the amount of oil and damages other functional components of the product.

Further, the battery 9 is connected with the microphone 8 and the atomizer through a positive electrode and a negative electrode.

Further, the casing 1 is provided with an oil injection hole 112, and the tobacco tar chamber is sealed by an oil injection plug 111 arranged on the oil injection hole 112.

Further, the sealing sleeve 3, the sealing plug 5, the sealing ring 101 and the sealing ring of fixing member 6 are made of transparent silica gel material.

Further, the heating wire 102 is ceramic heating wire.

Further, the atomizer uses the microphone 8 (pneumatic switch) to start the heating wire 102, and the battery circuit will work once the user inhales air.

The working principle of the disposable electronic cigarette:

1. In the loop lines of the positive electrode and the negative electrode of the battery 9, adding the battery switch 10 can achieve the switching function of. When the switch is turned on, the positive electrode and the negative electrode of the battery 9 are connected, and the battery 9 can work. When the switch is turned off, the, positive electrode and the, negative electrode of the battery 9 are disconnected, and the battery 9 is out of work, so that the loss of self-consumption of the battery 9 is avoided, and the capacity of the battery 9 is maintained. At the same time, it prevents the product from working automatically.
2. The sealing plug 5 is added inside the atomizer. When not in use, the sealing plug 5 seals the atomizing tube shell 106 to prevent the oil leakage through the atomizing tube shell 106 from damaging the pneumatic switch 8 and the battery 9, and to maintain the oil storage capacity not to be reduced. When ready to use, just pull out the sealing plug 5 and let the atomizing tube shell 106 ventilate.
3. The seal sleeve 3 is added to the shell of atomizer. When not in use, the sealing sleeve 3 sleeves the shell of atomizer, to completely isolate the oil from the external air, which can better solve the oil leakage and ensure the pure taste of the tobacco tar, while maintaining the appearance of clean and tidy. When in use, pull out the pulling valve 4 on the sealing sleeve -3 directly, and the oil inlet hole 105 is open, so that the tobacco tar can be imported, and the product can be used.

Transparent silica gel is a colourless or skin-coloured oily oil. It becomes a soft elastic material after vulcanization. It can be used for a long time in the temperature range of −65 C. to 200 C. and keep its soft and elastic properties. It has electrical and chemical stability, water resistance, ozone resistance, climate aging resistance, non-corrosive, physiological inertia, non-toxic and odorless, and low linear shrinkage. Transparent silica gel can be divided into additive transparent silica gel and condensation silica gel. Transparent silica gel has good electrical insulation performance. Its dielectric loss, voltage resistance, arc resistance, corona resistance, volume resistance coefficient and surface resistance coefficient are top among the top insulating materials, and their electrical properties are little affected by temperature and frequency. Therefore, they are a kind of stable electrical insulation material, which are widely used in the electronic and electrical industries. Transparent silica gel not only has excellent heat resistance, but also has excellent water resistance, which is the guarantee of high reliability of electrical equipment in wet condition.

In summary, the on-off function of the battery switch, namely the function of disconnecting and connecting the positive and negative electrodes of the battery is added by the present disclosure. There are many kinds of shapes, such as mechanical switch and touch switch, but the function and principle are to disconnect at off-work time and connect at working time. In short, the function is to maintain the power consumption of the battery and prevent the loss of self-consuming power of the battery; and to prevent the product from working automatically because of the external environment. The added sealing plug is to seal without leaking, to prevent leaking from damaging other components of the product. The shape and position can be in many ways, but the principle is that the sealing does not allow the oil to penetrate. The added sealing sleeve is to seal the oil away from the outside air; there are many kinds of shapes and ways. The principle is to seal (disconnect) the contact between the oil and the outside air, to solve the oil leakage better and ensure the pure taste of fume, while maintaining a clean and tidy appearance.

The foregoing is only a specific embodiment of the present disclosure, but the scope of protection of the present disclosure is not limited thereto. Any modifications or substitutions that can easily be thought by any ordinary person skilled in the art within the scope of the present disclosure shall be covered within the scope of protection of the present disclosure. Therefore, the scope of protection of the present disclosure shall be subject to the scope of protection of the claims. Unless otherwise defined, the technical and scientific terms used herein have the same meaning as those commonly understood by those skilled in the technical field of the present disclosure. The terminology used in the description of the present disclosure herein is for the purpose of describing specific embodiments only, not to limit the present disclosure.

1. A disposable electronic cigarette, comprising a casing, a bottom cover is arranged at the bottom of the casing; an atomizer is accommodated in the casing, wherein the atomizer passes through a sealing ring of a fixing member to arrange on the fixing member; the fixing member is further provided with a microphone; the fixing member divides the electronic cigarette into a top chamber and a bottom chamber, the bottom chamber is provided with a battery, and the top chamber opens an atomizing tube shell and an tobacco tar chamber; the atomizing tube shell is connected to the atomizer and is not in communication with the tobacco tar chamber; the bottom chamber is further provided with a battery switch, the battery switch is connected to the battery to control on, and off of the battery.

2. The disposable electronic cigarette according to claim 1, wherein, the atomizer comprises an atomizing tube, a heating wire, a silicone pad and a sealing ring; the sealing ring, the heating wire and the silicone pad are arranged in sequence in the atomizing tube, the sealing ring is arranged at one end far from the fixing member, the atomizing tube is provided with an oil inlet hole, and the atomizer is connected with the tobacco tar chamber through the oil inlet hole.

3. The disposable electronic cigarette according to claim 1, wherein, an external part of the atomizer is provided with a sealing sleeve, and the sealing sleeve isolates the connection between the tobacco tar chamber and the atomizer.

4. The disposable electronic cigarette according to claim 3, wherein, a pulling valve is provided in the sealing sleeve; pulling out of the pulling valve controls the connection between the oil inlet hole and the tobacco tar chamber.

5. The disposable electronic cigarette according to claim 1, wherein, a sealing plug is provided inside the atomizer; the sealing plug is capable of passing through the atomizing tube shell to isolate the atomizer from contacting with tobacco tar and gas.

6. The disposable electronic cigarette according to claim 1, wherein, the battery is connected with the microphone and the atomizer through a positive electrode and a negative electrode.

7. The disposable electronic cigarette according to claim 6, wherein, the casing is provided with an oil injection hole, and the tobacco tar chamber is sealed by an oil injection plug arranged on the oil injection hole.

8. The disposable electronic cigarette according to claim 3, wherein, the sealing sleeve, the, sealing plug, the sealing ring and the sealing ring of fixing member are made of transparent silica gel material.

9. The disposable electronic cigarette according to claim 8, wherein, the heating wire is ceramic heating wire.
